(19) United States
(12) Patent Application Publication
(10) Pub. No.: US 2006/0215693 A1
(43) Pub. Date: Sep. 28, 2006

(54) Method for transmitting data packages

(76) Inventor: Miguel De Vega Rodrigo, Woluwe St. Lambert Brussels (BE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/569,780

(22) PCT Filed: Aug. 10, 2004
(86) PCT No.: PCT/EP04/51756

§ 371 Date: Feb. 24, 2006

(30) Foreign Application Priority Data
Aug. 25, 2003 (DE) 103 39 039.1

(51) Int. Cl. H04J 3/16; H04J 3/22; H04J 3/18

(52) U.S. Cl. 370/468; 370/477

(57) ABSTRACT

After transmitting a data burst containing several data packages, the transmission channel of the same end node remains open for the transmission of other data packages “on the fly”. The connection is interrupted when another end node requires capacity for transmitting its data burst.

### CROSS REFERENCE TO RELATED APPLICATIONS

This application is the U.S. National Stage of International Application No. PCT/EP2004/051756, filed Aug. 10, 2004 and claims the benefit thereof. The International Application claims the benefits of German application No. 10339039.1 DE filed Aug. 25, 2003, both of the applications are incorporated by reference herein in their entirety.

### FIELD OF INVENTION

The invention relates to a method for transmitting data packets between network nodes of an optical network, wherein a transmission channel is first reserved, the connection is then switched and transmission subsequently takes place in data bursts each containing a plurality of data packets.

### BACKGROUND OF INVENTION

For data transmission over future optical networks, so-called optical burst switching OBS will be used, whereby a plurality of data packets (e.g. IP packets) are aggregated in so-called data bursts and then transmitted over a data channel of an appropriately designed optical network. The data channel corresponds to a particular wavelength of a wavelength multiplex signal (WDM/DWDM) which simultaneously transmits a plurality of individual optical signals (channels) over an optical fiber. A plurality of different communications to which associated burst sequences are assigned can be transmitted via one of these transmission channels. The higher the traffic volume, the longer the delays in the transmission of data bursts, as fewer spare time slots are available for transmitting the bursts. The blocking probability is reduced by a “two-way reservation OBS network”, 2WR-OBS, in which a reservation signal is transmitted and a receiving network node also signals acknowledgment.

The principles of the burst switching method are described e.g. by A. Sahara et al. in the article “Demonstrations of Optical Burst Data Switching Using Photonic MPLS Routers Operated by GMPLS Signaling” in Vol.1, OFC 2003, 23 Mar. 2003/Tuesday Afternoon, pages 220-222. This article considers in particular the two signaling methods “one-way signaling” and “two-way signaling” and their effect on data transmission reliability.

With so-called λ-switching in which a plurality of wavelengths (channels) of a WDM/DDWDM system are available for transmission, the switching granularity is one wavelength. Consequently, even at low traffic volume a complete transmission channel is occupied; this is termed high wavelength consumption. None of these known methods is optimum in terms of the essential criteria of time delay, blocking probability and transmission channel utilization.

### SUMMARY OF INVENTION

An object to the invention is therefore to specify an improved method for transmitting data packets between network nodes of an optical network.

This object is achieved by a method according to independent claims.

Advantageous further developments are set forth in the dependent claims.

The important advantage with this method is that the transmission channel continues to exist after a data burst has been transmitted. During this so-called consecutive phase, data packets are transmitted “on-the-fly” with no or minimal delay, as they are not first aggregated in a burst. The spare transmission capacity is used until the data channel, if no other channel or wavelength is available, is required by another connection to transmit its data packets aggregated in bursts.

Only during the consecutive phase can the existing connection be interrupted to transmit a data burst of another data source.

The advantageous functions of the known burst switching methods can be used in this system. For example, a connection is reserved according to the two-way reservation OBS principle in order to minimize the blocking probability.

Likewise the method according to the invention can be used for bidirectional connections, the end of the connection then being signaled in the consecutive phase to both network nodes affected.

### BRIEF DESCRIPTION OF THE DRAWINGS

The invention will be explained in greater detail with reference to the accompanying drawings in which:

FIG. 1 shows transmission capacity utilization with conventional optical burst switching (OBS),

FIG. 2 shows transmission capacity utilization with the method according to the invention,

FIG. 3 shows a block diagram of an optical network and

FIG. 4 shows a comparison of the method according to the invention with conventional methods.

### DETAILED DESCRIPTION OF INVENTION

FIG. 1 shows the transmission of data bursts over a data channel λ1 of a particular wavelength. First a data burst BURST1 containing a plurality of data packets is transmitted (the header having been previously transmitted on a wavelength in a service channel). When the burst is complete, initially no data is transmitted, which means that channel capacity WCA is wasted. It is only subsequently that a second data burst BURST2 of a second signal source is transmitted over the same data channel λ1 (the same wavelength). It is clear from FIG. 1 that only part of the channel capacity is utilized.

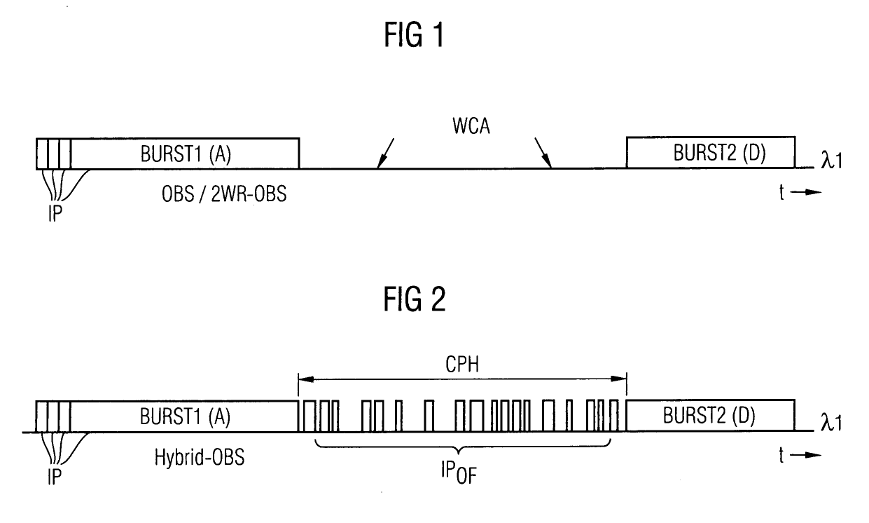

FIG. 2 illustrates the method according to the invention. After transmission of the first data burst BURST1 of the first data source, of a network node A, IP packets which, however, are not aggregated in a burst are then sent over the channel by the same node. Only when a burst BURST2 of another data source, a network node (D), is available for transmission is the transmission of data packets IPOF “on-the-fly” interrupted and the BURST2 transmitted. Because it is a combination of burst and data packet transmission, this method is termed hybrid OBS or “Adaptive Path Optical Network: APON”.

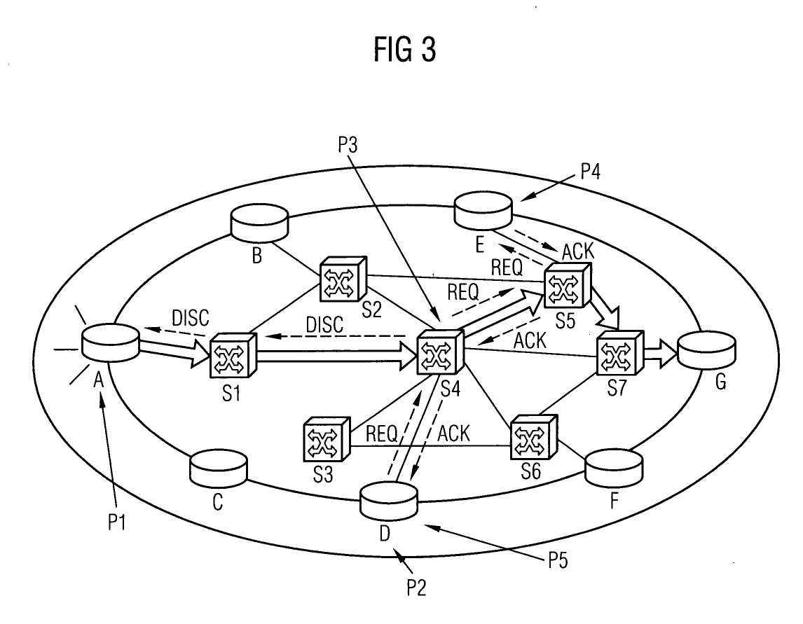

The method will now be explained in greater detail with reference to FIG. 3. This shows an optical network having optical switching devices S1 to S7 as well as end nodes A to G which, as the interface to the actual optical traffic network, receive data signals from different users in each case, convert them into data bursts and transmit them via the optical network to another network node which in turn feeds the data signal or different data signals to the users. In the opposite direction, data signals received via the optical traffic network are forwarded to the users.

We shall assume a first phase P1, the consecutive phase, in which the BURST1 has already been transmitted and the data packets are being transmitted “on-the-fly” from the end node A to the end node G. This phase continues until, in a second phase P2, the end node D, for example, uses a service channel to send a request REQ via the switching device S4 and the switching device S5 to the end node E to reserve channel capacity (a data channel) for its data burst BURST2. The switching device S4 receives this request and, as no other data channel (or wavelength) is free, informs the end node A by means of a disconnect signal DISC that the existing connection is being interrupted. The end node E to which D wants to send the data now receives the reservation request and sends an acknowledgment ACK back to the end node D. D receives this acknowledgment and can now transmit its data burst BURST2. The diagram in FIG. 2 shows this multiplex burst signal on the connection between the switching devices S4 and S5.

As a variant in phase 3, the switching device S4 waits for the acknowledgment signal of the end node E which regards the data packets transmitted “on-the-fly” as a free connection and therefore sends out its acknowledgment ACK nevertheless. Only then is the disconnect signal sent by the switching device S4 to the network node A.

When the connection D-E has been established, this connection now continues to exist for other data packets from D until it is interrupted once more by one of the end nodes, e.g. even by the end node A again.

The hybrid OBS method can likewise be used for bidirectional connections. The disconnect signal must then be sent to both of the connected network nodes.

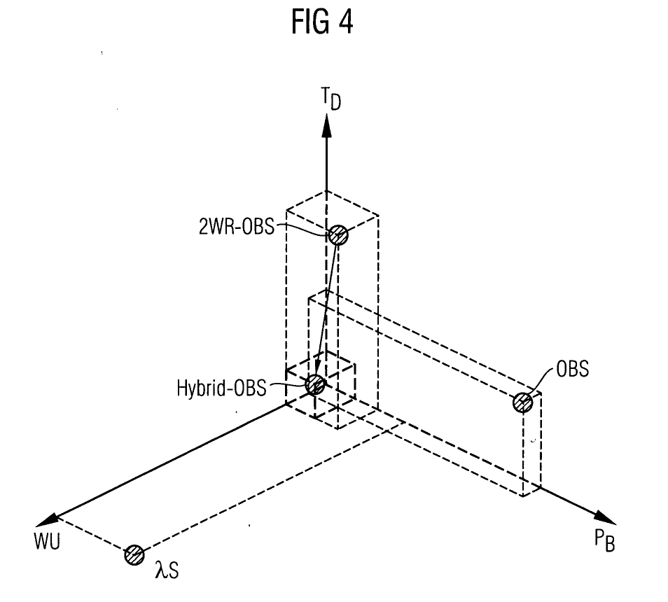

FIG. 4 shows the characteristics of hybrid OBS and of known methods: λ-switching XS, optical burst switching OBS and two-way reservation 2WR-OBS. In comparison with OBS and 2WR-OBS, the delay time TD for transmitting a data packet is low. Compared to λ-switching, in which a complete wavelength and therefore a complete transmission channel is always available, the delay time is naturally greater. The blocking probability PB is very low, as hybrid OBS likewise employs reservation and acknowledgment. It is lower than for the two OBS methods, as only a smaller number of bursts needs to be transmitted. The wavelength consumption (wavelength utilization) WU is on a par with 2WR-OBS, as IP data packet transmission is not taken into account because the consecutive phase is regarded by the system as spare capacity. Because of the short waiting times particularly during the consecutive phase, jitter is very low, and no signaling overhead is required during this phase.

To summarize, it can therefore be said that hybrid OBS offers significant advantages over existing burst transmission methods.

1.-8. (canceled)

9. A method for transmitting data packets between a first communications network node and a second communications network node of an communications optical network, comprising:
reserving a data channel;
transmitting a first data burst having aggregated data packets on the data channel;
retaining the data channel for a consecutive transmission phase after transmitting the first data;
transmitting additional data packets between the nodes during the consecutive transmission phase; and
terminating the connection only when the data channel is at least partially required for transmitting a second data burst between a third communications network node and a fourth communications network node of new connection.

10. The method according to claim 9,
wherein a request to reserve transmission capacity for the new connection is sent by a reservation-requiring network node via switching devices of the network to an end node,
wherein the third node is the reservation-requiring network node, and
wherein the fourth node is the end node.

11. The method according to claim 10, wherein transmission capacity for the new connection is only reserved during the consecutive transmission phase.

12. The method according to claim 10, wherein a disconnect signal is transmitted via the switching devices present in the devices present in the first connection to the first node.

13. The method according to claim 1 1, wherein a disconnect signal is transmitted via the switching devices present in the devices present in the first connection to the first node.

14. The method according to claim 10, wherein transmission capacity is reserved according to a two-way reservation optical burst switching principle via a request and an acknowledgement.

15. The method according to claim 14, wherein the transmission capacity is reserved for bidirectional connections.

16. The method according to claim 15, wherein to reserve the transmission capacity, the disconnect signal is sent to the first and second nodes.

17. The method according to claim 16, wherein a disconnect signal is only sent when an acknowledgement is issued by the end node receiving the request to reserve the transmission capacity.

18. The method according to claim 12, wherein a disconnect signal is only sent when an acknowledgement is issued by the end node receiving a request to reserve the transmission capacity.
